(19) United States
(12) Patent Application Publication
(10) Pub. No.: US 2026/0176103 A1
(43) Pub. Date: Jun. 25, 2026

(54) MANAGEMENT METHOD, MODULE, ELEVATOR POWER SUPPLY SYSTEM, ELEVATOR, ELECTRONIC DEVICE AND MEDIUM

(71) Applicant: Inventio AG, Hergiswil (CH)

(72) Inventor: Joe Zhou, Shanghai (CN)

(21) Appl. No.: 19/132,420

(22) PCT Filed: Nov. 30, 2023
(86) PCT No.: PCT/EP2023/083654

§ 371 Date: May 23, 2025

(30) Foreign Application Priority Data
Nov. 30, 2022 (EP) 22210448.1

(51) Int. Cl. B66B 1/06; B66B 1/34

(52) U.S. Cl. CPC B66B 1/06; B66B 1/34

(57) ABSTRACT

An elevator power supply system includes a charging module with an electrical switchable connection to an energy storage module and the energy storage module with an electrical switchable connection to a power consumption module. A system management method comprises: when the power supply system and/or power consumption module is in an off-peak period and a remaining power of the energy storage module is not sufficient to compensate for the power consumption of the power consumption module in a predetermined charging cycle, switching the charging module into an on state with the energy storage module so that the charging module charges the energy storage module; and when an amount of charge charged by the charging module to the energy storage module reaches a predetermined power threshold, switching the charging module into an off state with the energy storage module.

### FIELD

The present disclosure relates to the technical field of elevators, and more particularly, to a management method for an elevator power supply system, a management module, an elevator power supply system, an elevator, an electronic device, a readable storage medium and a program product.

### BACKGROUND

As elevators become more and more popular, the number of elevators becomes larger and larger. Many elevators need to be in working condition for 24 hours in a day, so the cost of electricity consumption during a peak period of electricity is high, and at the same time, it causes great pressure on a power supply system (also referred to as grid).

In view of this, the present disclosure provides a management method for an elevator power supply system, a management module, an elevator power supply system, an elevator, an electronic device, a readable storage medium and a program product with low cost, high intelligence and resource saving.

### SUMMARY

One aspect of the present disclosure provides a management method for an elevator power supply system, wherein the elevator power supply system includes a charging module and an energy storage module, the charging module is electrically connected with the energy storage module in a switchable way or connection, and the energy storage module is electrically connected with a power consumption module of the elevator in a switchable way or connection, wherein the method includes: when it is determined that the power supply system and/or elevator power supply system and/or power consumption module is in an off-peak period and the remaining power of the energy storage module is not sufficient to compensate for the power consumption of the power consumption module in a predetermined charging cycle, switching the charging module into an on state with the energy storage module so that the charging module can charge the energy storage module; and when an amount of charge charged by the charging module to the energy storage module reaches a power threshold, switching the charging module into an off state with the energy storage module.

Connected in a switchable way means above and in the following that the two devices, e.g. the charging module and the energy storage module, are electrically connected in a way in which the electrical connection is to be established and interrupted during the operation of the devices.

Charging cycle refers above and in the following to the process of charging the energy storage module form a low/no charged status to a fuller/fully charged status. The lifetime of a battery can be specified by the amount of charging cycles a battery can withstand before losing a certain amount of its capacity. Charging cycle refers to the duration of the charging process, i.e. is express as time, e.g. in seconds or hours.

It can be understood that the energy storage module may be used to store electrical energy for the use of the power consumption module. The power consumption module, for example, may be an elevator control unit, an elevator drive unit and other electrical units, and the charging module may be used to charge the energy storage module.

With the management method for the elevator power supply system according to the embodiment of the present disclosure, by determining that the current time is in the off-peak-period, the charging module can charge the energy storage module during the off-peak-period, thereby reducing the power consumption cost of the elevator, and at the same time, the power supply pressure on the power supply system (also referred to as grid) may be reduced. When it is determined that the remaining power of the energy storage module is not sufficient to compensate for the power consumption of the power consumption module in the predetermined charging cycle, the charging module is switched into an on state with the energy storage module so that the charging module can charge the energy storage module to ensure the necessity of charging. Only when the remaining power of the energy storage module is not sufficient to compensate for the power consumption of the power consumption module in the predetermined charging cycle, it will be charged, otherwise it will not be charged, thereby realizing the intelligence of the management method for the elevator power supply system and saving resources. When the amount of charge from the charging module to the energy storage module reaches the electric power threshold, the charging module is switched into an off state with the energy storage module, thereby further realizing the intelligence of the management method for the elevator power supply system.

With the management method for the elevator power supply system according to the embodiment of the present disclosure, by determining that the current time is in the off-peak period, the charging module can charge the energy storage module during the off-peak period, thereby reducing the power consumption cost of the elevator, and at the same time, the power supply pressure on the power supply system (also referred to as grid) may be reduced. When it is determined that the remaining power of the energy storage module is not sufficient to compensate for the power consumption of the power consumption module in the predetermined charging cycle, the charging module is switched into an on state with the energy storage module so that the charging module can charge the energy storage module to ensure the necessity of charging. Only when the remaining power of the energy storage module is not sufficient to compensate for the power consumption of the power consumption module in the predetermined charging cycle, it will be charged, otherwise it will not be charged, thereby realizing the intelligence of the management method for the elevator power supply system and saving resources. When the amount of charge charged by the charging module to the energy storage module reaches the electric power threshold, the charging module is switched into an off state with the energy storage module, thereby further realizing the intelligence of the management method for the elevator power supply system.

In some embodiments, the elevator power supply system further includes an energy conversion module, and the energy conversion module is electrically connected with the energy storage module in a switchable way, wherein the method further includes: when an elevator car is in a moving state, switching the energy conversion module into an on state with the energy storage module so that the energy conversion module converts kinetic energy of the elevator car into electrical energy that is in turn transmitted to the energy storage module.

In some embodiments, a step of determining that the power supply system and/or elevator power supply system and/or power consumption module is in an off-peak period includes: determining whether the current time falls into a predefined elevator-off-peak period; and/or when the current time falls into the predefined elevator-off-peak period, determining that the current time is in a grid-off-peak period.

Elevator-off-peak period above and in the following means the off-power-peak period of an elevator, i.e., to the period, in which the elevator does consume less power than in another period. For example, an elevator-off-peak period can be after rush hour and before lunch, e.g. from 9 to 10 am.

Grid-off-peak period above and in the following refers to a time period, in which the electricity demand within the electricity grid is lower than in other time period(s). A grid-off-peak range can for example be the period between 6 pm and 6 am or between 10 pm and 5 am.

In some embodiments, a step of predetermining the charging cycle includes: obtaining a cycle coefficient of the energy storage module, a maximum discharging times in a lifetime of the energy storage module, and an estimated service life of the elevator; and calculating the charging cycle according to the cycle coefficient, the maximum discharging times and the estimated service life of the elevator.

It can be understood that the calculation of the charging cycle according to the cycle coefficient, the maximum discharging times and the estimated service life of the elevator, may be realized by formula,

T=k×CT/Y,
wherein: k represents the cycle coefficient, for example, k may be less than or equal to 1, which may ensure that the maximum discharging times in a lifetime of the energy storage module is fully utilized; CT represents the maximum discharging times in a lifetime of the energy storage module; and Y represents the estimated service life of the elevator. Cycle coefficient of the energy storage module above and in the following refers to a percentual (expressed as factor, i.e. %/100) use of the overall capacity of the energy storage. A 0.9 cycle coefficient results in a 90% “use” of the overall discharging times specified for the energy storage. In other words, it is a safety factor used for the above calculation to ensure that the battery lasts for the expected lifetime of the elevator.

In some embodiments, a step of determining that the remaining power of the energy storage module is not sufficient to compensate for the power consumption of the power consumption module in the predetermined charging cycle includes: comparing a ratio of the remaining power of the energy storage module to the power consumption of the power consumption module in a unit cycle with the charging cycle; and when the ratio is smaller than the charging cycle, determining that the remaining power of the energy storage module is not sufficient to compensate for the power consumption of the power consumption module in the predetermined charging cycle.

Ratio of the remaining power means above and in the following a current state of charge expressed as a part of the overall capacity of the energy storage. In other words, it is a current state of charge of the energy storage expressed as a percentage of the overall capacity.

Unit cycle refers above and in the following to a cycle with a predefined length, i.e. time.

Another aspect of the present disclosure provides a management module of an elevator power supply system, wherein the elevator power supply system includes a charging module and an energy storage module, the charging module is electrically connected with the energy storage module in a switchable way, and the energy storage module is electrically connected with a power consumption module of the elevator in a switchable way, wherein the management module includes: a first control unit that is configured to switch the charging module into an on state with the energy storage module so that the charging module can charge the energy storage module when it is determined that the power supply system and/or elevator power supply system and/or power consumption module is in an off-peak period and the remaining power of the energy storage module is not sufficient to compensate for the power consumption of the power consumption module in a predetermined charging cycle; and a second control unit that is configured to switch the charging module into an off state with the energy storage module when an amount of charge charged by the charging module to the energy storage module reaches a power threshold. In an embodiment the first and the second control unit are combined in one physical control unit.

A further aspect of the present disclosure provides an elevator power supply system including: the management module as described above; a charging module that is in communication with the management module; and an energy storage module that is in communication with the management module and is electrically connected with the charging module in a switchable way, wherein the management module is configured to control an on-off state between the energy storage module and the charging module, and to control an on-off state between a power consumption module of the elevator and the energy storage module.

Control an on-off-state above and in the following refers to switching between the electrical connected (on) and electrical disconnected (off) state of two devices, e.g. turning on and off the electrical connection between the charging module and the energy storage. In some embodiments, the energy storage module and the power consumption module are connected through a DC-AC power supply.

DC-AC power supply is also referred to as a DC-AC-converter, converter or inverter converts DC voltage (of a DC bus) into an AC voltage.

Another further aspect of the present disclosure provides an elevator including: the elevator power supply system as described above; and a power consumption module, wherein the management module is configured to control an on-off state between the power consumption module and the energy storage module.

Still another further aspect of the present disclosure provides an electronic device including: one or more processors; one or more memories for storing executable instructions that are executable by the processors to implement the method as described above.

Still another further aspect of the present disclosure provides a readable storage medium, wherein executable instructions, that are executable by a processor to implement the method as described above, are stored on the storage medium.

Still another further aspect of the present disclosure provides a program product including a program, wherein the program includes one or more executable instructions that are executable by a processor to implement the method as described above.

By means of the following description of exemplary embodiments of the present disclosure by referring to accompanying drawings, the above and other objects, features and advantages of the present disclosure will be clearer:

### DESCRIPTION OF THE DRAWINGS

FIG. 1 schematically shows a flowchart of a management method for an elevator power supply system according to an embodiment of the present disclosure;

FIG. 2 schematically shows a flowchart of a management method for an elevator power supply system according to an embodiment of the present disclosure;

FIG. 3 schematically shows a flowchart of determining that the power supply system and/or elevator power supply system and/or power consumption module is in an off-peak period according to an embodiment of the present disclosure;

FIG. 4 schematically shows a flowchart of predetermining the charging cycle according to an embodiment of the present disclosure;

FIG. 5 schematically shows a flowchart of determining that the remaining power of the energy storage module is not sufficient to compensate for the power consumption of the power consumption module in the predetermined charging cycle according to an embodiment of the present disclosure;

FIG. 6 schematically shows a structural block diagram of a management module of an elevator power supply system according to an embodiment of the present disclosure;

FIG. 7 schematically shows an elevator power supply system according to an embodiment of the present disclosure;

FIG. 8 schematically shows an elevator according to an embodiment of the present disclosure; and

FIG. 9 schematically shows a block diagram of an electronic device according to an embodiment of the present disclosure.

### DETAILED DESCRIPTION

Embodiments of the present disclosure will be described below with reference to the accompanying drawings. It should be understood, however, that these descriptions are exemplary only, and are not intended to limit the scope of the present disclosure. Also, in the following description, descriptions of well-known structures and techniques are omitted to avoid unnecessarily obscuring the concepts of the present disclosure.

As elevators become more and more popular, the number of elevators becomes larger and larger. Many elevators need to be in working condition for 24 hours in a day, so the cost of electricity consumption during a peak period of electricity is high, and at the same time, it causes great pressure on a power supply system (also referred to as grid).

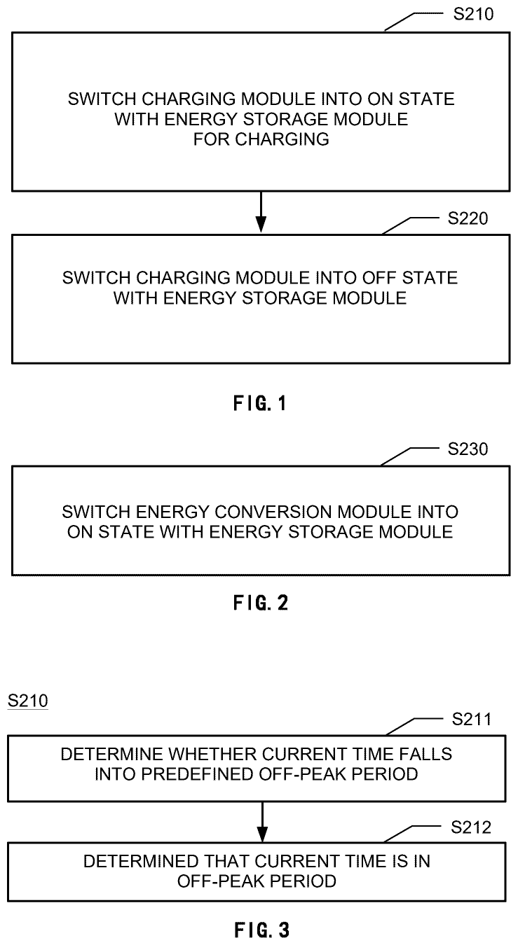

A management method for an elevator power supply system, a management module, an elevator power supply system, an elevator, an electronic device, a readable storage medium and a program product according to embodiments of the present invention are described below with reference to FIG. 1-FIG. 9.

FIG. 1 schematically shows a flowchart of a management method for an elevator power supply system according to an embodiment of the present disclosure. The elevator power supply system includes a charging module and an energy storage module, the charging module is electrically connected with the energy storage module in a switchable way, and the energy storage module is electrically connected with the power consumption module of an elevator in a switchable way.

As shown in FIG. 1, the management method of the elevator power supply system according to the embodiment includes an operation S210 and an operation S220.

In the operation S210, when it is determined that the power supply system and/or elevator power supply system and/or power consumption module is in an off-peak period and the remaining power of the energy storage module is not sufficient to compensate for the power consumption of the power consumption module in a predetermined charging cycle, the charging module is switched into an on state with the energy storage module so that the charging module can charge the energy storage module.

In the operation S220, when an amount of charge charged by the charging module to the energy storage module reaches a predetermined power threshold, the charging module is switched into an off state with the energy storage module.

FIG. 2 schematically shows a flowchart of a management method for an elevator power supply system according to an embodiment of the present disclosure. The elevator power supply system further includes an energy conversion module that is electrically connected with the energy storage module in a switchable way. The management method of the elevator power supply system further includes an operation S230.

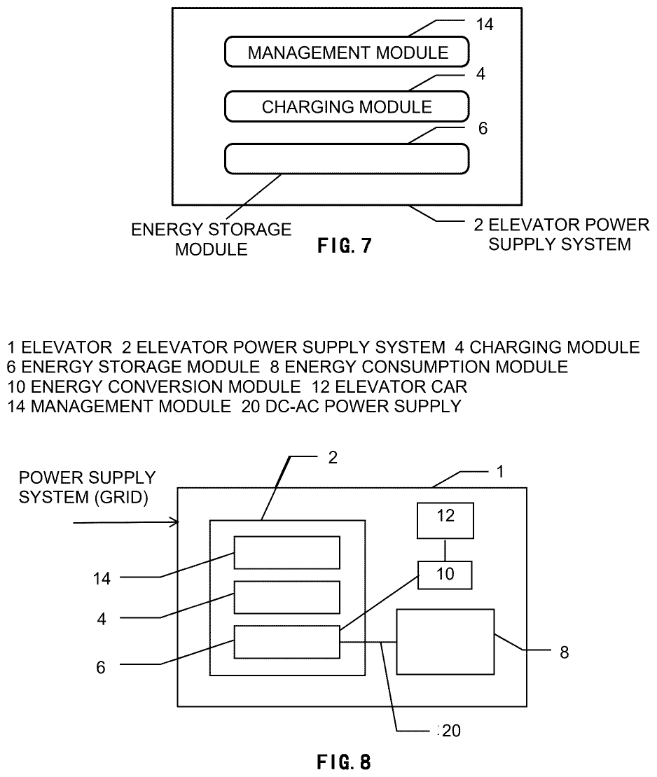

In the operation S230, when an elevator car is in a moving state, the energy conversion module is switched into an on state with the energy storage module so that the energy conversion module converts kinetic energy of the elevator car into electrical energy that is in turn transmitted to the energy storage module. In this way, the electric energy of the elevator movement may be recycled, and the energy may be fully utilized to realize energy saving and environmental protection. See FIG. 8 showing an energy conversion module 10 for converting kinetic energy of an elevator car 12 into electrical energy that is transmitted to a connected energy storage module 6.

FIG. 3 schematically shows a flowchart of determining that the power supply system and/or elevator power supply system and/or power consumption module is in an off-peak period according to an embodiment of the present disclosure. The operation S210, for determining that the power supply system and/or elevator power supply system and/or power consumption module is in an off-peak period, includes an operation S211 and an operation S212.

In the operation S211, whether the current time falls into a predefined off-peak range is determined.

In the operation S212, when the current time falls into the predefined off-peak range, it is determined that the current time is in the off-peak period. It can be understood that the off-peak range may be a value, or the off-peak range may be a range. By means of the operations S211 and S212, it may be facilitated to realizing the operation of S210 to determine that the power supply system and/or elevator power supply system and/or power consumption module is in the off-peak period.

In some examples, when the current time does not fall into the predefined off-peak range, it is determined that the current time is in a power peak period, and the energy storage module may not be charged.

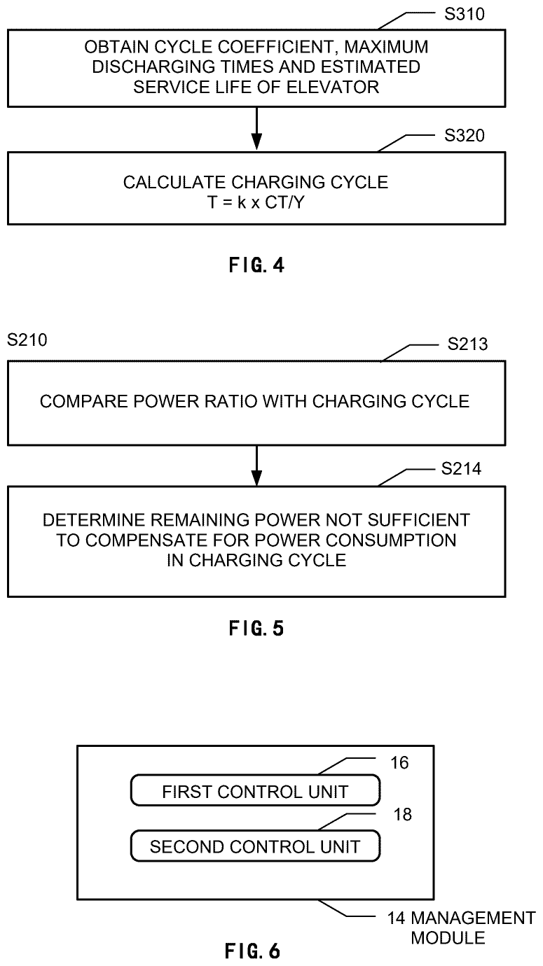

FIG. 4 schematically shows a flowchart of predetermining the charging cycle according to an embodiment of the present disclosure.

Predetermining the charging cycle includes an operation S310 and an operation S320. In the operation S310, a cycle coefficient of the energy storage module, a maximum discharging times in a lifetime of the energy storage module, and an estimated service life of the elevator are obtained.

In the operation S320, the charging cycle is calculated according to the cycle coefficient, the maximum discharging times and the estimated service life of the elevator. It can be understood that the calculation of the charging cycle according to the cycle coefficient, the maximum discharging times and the estimated service life of the elevator, may be realized by formula,

T=k×CT/Y,
wherein: k represents the cycle coefficient, for example, k may be less than or equal to 1, which may ensure that the maximum discharging times in a lifetime of the energy storage module is fully utilized; CT represents the maximum discharging times in a lifetime of the energy storage module; and Y represents the estimated service life of the elevator. By means of the operations S310 and S320, it may be facilitated to predetermining the charging cycle.

FIG. 5 schematically shows a flowchart of determining that the remaining power of the energy storage module is not sufficient to compensate for the power consumption of the power consumption module in the predetermined charging cycle according to an embodiment of the present disclosure.

The operation S210, for determining that the remaining power of the energy storage module is not sufficient to compensate for the power consumption of the power consumption module in the predetermined charging cycle, includes an operation S213 and an operation S214.

In the operation S213, a ratio of the remaining power of the energy storage module to the power consumption of the power consumption module in a unit cycle is compared with the charging cycle.

In the operation S214, when the ratio is smaller than the charging cycle, it is determined that the remaining power of the energy storage module is not sufficient to compensate for the power consumption of the power consumption module in the predetermined charging cycle.

By means of the operations S213 and S214, it may be facilitated to determining that the remaining power of the energy storage module is not sufficient to compensate for the power consumption of the power consumption module in the predetermined charging cycle.

Based on the above management method for the elevator power supply system, the present disclosure also provides a management module 14 of the elevator power supply system. The management module 14 of the elevator power supply system will be described in detail below with reference to FIG. 6.

FIG. 6 schematically shows a structural block diagram of a management module 14 of an elevator power supply system according to an embodiment of the present disclosure. The elevator power supply system includes a charging module and an energy storage module, the charging module is electrically connected with the energy storage module in a switchable way, and the energy storage module is electrically connected with a power consumption module of the elevator in a switchable way.

The management module 14 of the elevator power supply system includes a first control unit 16 and a second control unit 18.

The first control unit 16 is configured to perform the operation S210, so as to switch the charging module into an on state with the energy storage module so that the charging module can charge the energy storage module when it is determined that the power supply system and/or elevator power supply system and/or power consumption module is in an off-peak period and the remaining power of the energy storage module is not sufficient to compensate for the power consumption of the power consumption module in a predetermined charging cycle.

The second control unit 18 is configured to perform the operation S220 so as to switch the charging module into an off state with the energy storage module when an amount of charge charged by the charging module to the energy storage module reaches a predetermined power threshold.

With the management module 14 of the elevator power supply system according to the embodiment of the present disclosure, by determining that the current time is in the off-peak period, the charging module can charge the energy storage module during the off-peak period, thereby reducing the power consumption cost of the elevator, and at the same time, the power supply pressure on the power supply system (also referred to as grid) may be reduced. When it is determined that the remaining power of the energy storage module is not sufficient to compensate for the power consumption of the power consumption module in the predetermined charging cycle, the charging module is switched into an on state with the energy storage module so that the charging module can charge the energy storage module to ensure the necessity of charging. Only when the remaining power of the energy storage module is not sufficient to compensate for the power consumption of the power consumption module in the predetermined charging cycle, it will be charged, otherwise it will not be charged, thereby realizing the intelligence of the management module of the elevator power supply system and saving resources. When the amount of charge charged by the charging module to the energy storage module reaches the predetermined electric power threshold, the charging module is switched into an off state with the energy storage module, thereby further realizing the intelligence of the management module of the elevator power supply system.

In addition, according to the embodiment of the present disclosure, any plurality of modules in the first control unit 16 and the second control unit 18 may be combined into one module for implementation, or any one of the modules may be split into a plurality of modules. Alternatively, at least a part of the functionality of one or more of these modules may be combined with at least a part of the functionality of other modules and implemented in one module.

According to the embodiment of the present disclosure, at least one of the first control unit 16 and the second control unit 18 may be at least partially implemented as a hardware circuit, such as a Field Programmable Gate Array (FPGA), a Programmable Logic Array (PLA), a system-on-chip, a system-on-substrate, a system-on-package, an Application Specific Integrated Circuit (ASIC), or it can be realized by hardware or firmware such as any other reasonable way of integrating or encapsulating the circuit, or by any one of the three implementation methods of software, hardware and firmware or by an appropriate combination of any of them.

Alternatively, at least one of the first control unit 16 and the second control unit 18 may be implemented, at least in part, as a computer program module which, when executed, may perform corresponding functions.

FIG. 7 schematically shows an elevator power supply system 2 according to an embodiment of the present disclosure.

The elevator power supply system 2 includes a management module 14, a charging module 4 and an energy storage module 6.

The management module is the management module 14 as described above. The charging module 4 is in communication with the management module 14. The energy storage module 6 is in communication with the management module 14, and the energy storage module 6 is electrically connected with the charging module 4 in a switchable way. The management module 14 is configured to control an on-off state between the energy storage module 6 and the charging module 4, and to control an on-off state between a power consumption module 8 of the elevator 1 and the energy storage module 6 (see FIG. 8).

With the elevator power supply system 2 according to the embodiment of the present disclosure, by determining that the current time is in the off-peak period by means of the management module 14, the charging module 4 can charge the energy storage module 6 during the off-peak period, thereby reducing the power consumption cost of the elevator, and at the same time, the power supply pressure on the power supply system (also referred to as grid) may be reduced. When it is determined that the remaining power of the energy storage module 6 is not sufficient to compensate for the power consumption of the power consumption module 8 in the predetermined charging cycle by means of the management module 14, the charging module 4 is switched into an on state with the energy storage module 6 so that the charging module 4 can charge the energy storage module 6 to ensure the necessity of charging. Only when the remaining power of the energy storage module 6 is not sufficient to compensate for the power consumption of the power consumption module 8 in the predetermined charging cycle, it will be charged, otherwise it will not be charged, thereby realizing the intelligence of the management module of the elevator power supply system and saving resources. When the amount of charge charged by the charging module 4 to the energy storage module 6 reaches the electric power threshold, the charging module 4 is switched into an off state with the energy storage module 6, thereby further realizing the intelligence of the management module of the elevator power supply system.

In some embodiments of the present disclosure, as shown in FIG. 8, the energy storage module 6 is connected with the power consumption module 8 through a DC-AC power supply 20. Therefore, the structure of the driving device is simple as the elevator 1 of the present disclosure does not need an intervention of an external power source, and the cost is low as only the conversion of the DC-AC power source 20 is required. In addition, the driving and control system is more stable and reliable.

FIG. 8 schematically shows an elevator 1 according to an embodiment of the present disclosure.

The elevator 1 includes an elevator power supply system 2 and a power consumption module 8. Also included, as described above, are the energy conversion module 10 and the elevator car 12.

The elevator power supply system 2 is the elevator power supply system 2 as described above.

The management module 14 is configured to control an on-off state between the power consumption module 8 of the elevator 1 and the energy storage module 6. With the elevator 1 according to the embodiment of the present disclosure, by determining that the current time is in the off-peak period by means of the management module 14, the charging module 4 can charge the energy storage module 6 during the off-peak period, thereby reducing the power consumption cost of the elevator, and at the same time, the power supply pressure on the power supply system (also referred to as grid) may be reduced. When it is determined that the remaining power of the energy storage module 6 is not sufficient to compensate for the power consumption of the power consumption module 8 in the predetermined charging cycle by means of the management module 14, the charging module 4 is switched into an on state with the energy storage module 6 so that the charging module 4 can charge the energy storage module 6 to ensure the necessity of charging. Only when the remaining power of the energy storage module 6 is not sufficient to compensate for the power consumption of the power consumption module 8 in the predetermined charging cycle, it will be charged, otherwise it will not be charged, thereby realizing the intelligence of the management module of the elevator power supply system and saving resources. When the amount of charge charged by the charging module 4 to the energy storage module 6 reaches the electric power threshold, the charging module 4 is switched into an off state with the energy storage module 6, thereby further realizing the intelligence of the management module of the elevator power supply system.

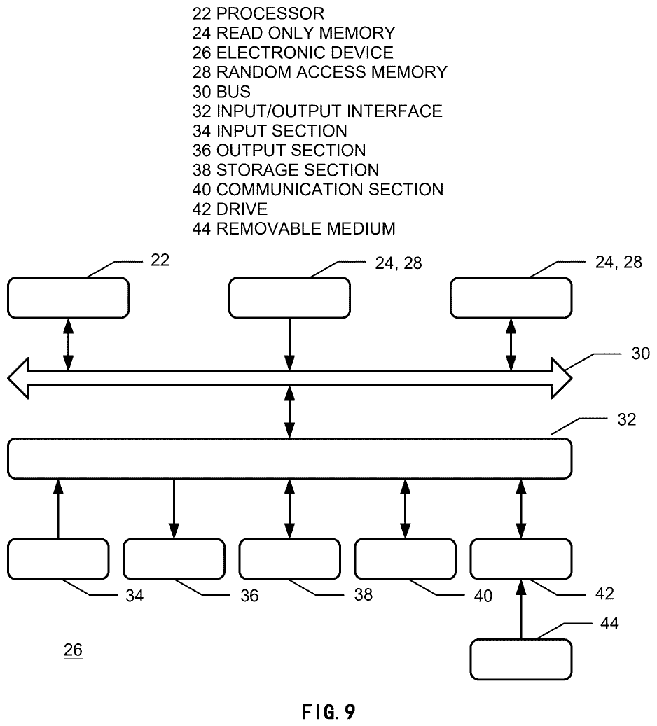

FIG. 9 schematically shows a block diagram of an electronic device according to an embodiment of the present disclosure.

As shown in FIG. 9, the electronic device 26 according to an embodiment of the present disclosure includes a processor 22, which can perform various appropriate actions and processes according to a program stored in a read only memory (ROM) 24 or a program loaded from a storage part 38 into a random access memory (RAM) 28. The processor 22 may include, for example, a general-purpose microprocessor (such as a CPU), an instruction set processor and/or a related chipset and/or a special-purpose microprocessor (such as an application specific integrated circuit (ASIC)), and the like. The processor 22 may also include an on-board memory for caching purposes. The processor 22 may include a single processing unit or a plurality of processing units for performing different actions of the method flow according to an embodiment of the present disclosure.

In RAM 28, various programs and data needed for the operation of electronic device 26 are stored. The processor 22, the ROM 24 and the RAM 28 are connected to each other through the bus 30. The processor 22 performs various operations of the method flow according to the embodiments of the present disclosure by executing programs in ROM 24 and/or RAM 28. It should be noted that the program may also be stored in one or more memories other than the ROM 24 and the RAM 28. The processor 22 may also perform various operations of the method flow according to embodiments of the present disclosure by executing programs stored in the one or more memories.

According to an embodiment of the present disclosure, the electronic device 26 can also include an input/output (I/O) interface 32, which is also connected to the bus 30. The electronic device 26 may also include one or more of the following components connected to the I/O interface 32: an input section 34 including a keyboard, a mouse, and the like; an output section 36 such as a cathode ray tube (CRT), a liquid crystal display (LCD), and the like, and a loudspeaker; a storage section 38 including a hard disk or the like; and a communication section 40 including a network interface card such as a LAN card, a modem, and the like. The communication section 40 performs communication processing via a network such as the Internet. The drive 42 is also connected to the input/output (I/O) interface 32 as required. A removable medium 44, such as a magnetic disk, an optical disk, a magneto-optical disk, a semiconductor memory, and the like, is mounted on the drive 42 as required, so that computer programs read from it can be mounted into the storage section 38 as required.

The present disclosure also provides a computer-readable storage medium, which may be included in the device/apparatus/system described in the above embodiment; it may also exist alone without being assembled into the device/apparatus/system. The above-mentioned computer-readable storage medium carries one or more programs, and when the one or more programs are executed, the method according to the embodiment of the present disclosure is implemented.

According to the embodiment of the present disclosure, the computer-readable storage medium may be a nonvolatile computer-readable storage medium, for example, it can include but not limited to: portable computer disk, hard disk, random access memory (RAM), read only memory (ROM), erasable programmable read only memory (EPROM or flash memory), portable compact disk read only memory (CD-ROM), optical storage device, magnetic storage device or any suitable combination of the above. In the present disclosure, a computer-readable storage medium may be any tangible medium that contains or stores a program that can be used by or in conjunction with an instruction execution system, apparatus, or device. For example, according to embodiments of the present disclosure, a computer-readable storage medium may include one or more memories other than ROM 24 and/or RAM 28 described above.

The embodiment of the present disclosure also includes a computer program product, which includes a computer program, and the computer program includes program code for performing the method illustrated in the flowchart. When the computer program product is run in a computer system, the program code is used to cause the computer system to implement the methods of the embodiments of the present disclosure.

When the computer program is executed by the processor 22, the above-mentioned functions defined in the system/apparatus of the embodiment of the present disclosure are performed. According to the embodiment of the present disclosure, the systems, apparatuses, modules, units and the like described above can be realized by computer program modules.

In one embodiment, the computer program may rely on a tangible storage medium such as an optical storage device, a magnetic storage device, or the like. In another embodiment, the computer program may also be transmitted, distributed in the form of a signal over a network medium, and downloaded and installed through the communication section 40, and/or installed from the removable medium 44. The program code embodied by the computer program may be transmitted using any suitable network medium, including but not limited to: wireless, wired, etc., or any suitable combination of the foregoing.

In such an embodiment, the computer program may be downloaded and installed from the network through the communication section 40, and/or installed from the removable medium 44. When the computer program is executed by the processor 22, the above-described functions defined in the system of the embodiment of the present disclosure are executed. According to embodiments of the present disclosure, the above-described systems, devices, apparatuses, modules, units, etc. can be implemented by computer program modules.

According to the embodiments of the present disclosure, the program code for executing the computer program provided by the embodiments of the present disclosure may be written in one or any combination of multiple programming languages, and specifically, high-level procedures and/or object-oriented programming language, and/or assembly/machine language may be used to implement these computational programs. Programming languages include, but are not limited to, languages such as Java, C++, python, “C” or similar programming languages. The program code may execute entirely on the user computing device, partly on the user device, partly on a remote computing device, or entirely on the remote computing device or server. Where remote computing devices are involved, the remote computing devices may be connected to the user computing device by any kind of network, including a local area network (LAN) or wide area network (WAN), or may be connected to an external computing device (e.g. using an Internet service provider business via an Internet connection).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or section of code that contains one or more executable instructions for implementing the specified logical function. It should also be noted that, in some alternative implementations, the functions noted in the blocks may occur out of the order noted in the figures. For example, two blocks shown in succession may, in fact, be executed basically in parallel, or the blocks may sometimes be executed in the reverse order, depending upon the function involved. It is also noted that each block of the block diagrams or flowchart illustrations, and combinations of blocks in the block diagrams or flowchart illustrations, can be implemented in special purpose hardware-based systems that perform the specified functions or operations, or can be implemented using a combination of special purpose hardware and computer instructions.

Those skilled in the art can understand that the features recorded in various embodiments and/or claims of the present disclosure can be assembled and/or combined in a variety of ways, even if such assemblies and/or combinations is not explicitly recorded in the present disclosure. In particular, without departing from the spirit and teachings of the present disclosure, the features recorded in various embodiments and/or claims of the present disclosure can be assembled and/or combined in a variety of ways. All these assemblies and/or combinations fall within the scope of the present disclosure.

The embodiments of the present disclosure have been described above. However, these embodiments are only for the purpose of illustration, not to limit the scope of the present disclosure. Although the embodiments are described separately above, this does not mean that the measures in the embodiments cannot be used together advantageously. The scope of the present disclosure is defined by the appended claims and their equivalents. Without departing from the scope of this disclosure, those skilled in the art can make a variety of substitutions and modifications, which should fall within the scope of this disclosure.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. A management method for managing an elevator power supply system of an elevator, wherein the elevator power supply system is connected to a power supply system to receive electrical power, the elevator power supply system including a charging module and an energy storage module, the charging module being electrically connected with the energy storage module by a switchable connection, and the energy storage module being electrically connected with a power consumption module of the elevator by a switchable connection, the method comprising steps of:
in response to the power supply system and/or elevator power supply system and/or the power consumption module being in an off-peak period and a remaining power of the energy storage module not being sufficient to compensate for a power consumption of the power consumption module in a predetermined charging cycle, switching the charging module into an on state with the energy storage module such that the charging module charges the energy storage module; and
in response to an amount of charge transmitted by the charging module to the energy storage module reaching a predetermined power threshold, switching the charging module into an off state with the energy storage module.

14. The management method according to claim 13 wherein the elevator power supply system includes an energy conversion module that is electrically connected with the energy storage module by a switchable connection, and including while an elevator car of the elevator is moving, switching the energy conversion module into an on state with the energy storage module such that the energy conversion module converts a kinetic energy of the moving elevator car into electrical energy and transmitting the electrical energy to the energy storage module.

15. The management method according to claim 13 including determining that the power supply system and/or the elevator power supply system and/or the power consumption module is in the off-peak period by determining whether a current time falls into a predefined elevator-off-peak period and/or, when the current time falls into the predefined elevator-off-peak-period, determining that the current time is in a grid-off-peak-period of the power supply system.

16. The management method according to claim 13 wherein a step of predetermining the predetermined charging cycle comprises:
obtaining a cycle coefficient of the energy storage module, a maximum discharging times in a lifetime of the energy storage module, and an estimated service life of the elevator; and
calculating the predetermined charging cycle based upon the cycle coefficient, the maximum discharging times and the estimated service life of the elevator.

17. The management method according to claim 13 wherein a step of determining that the remaining power of the energy storage module is not sufficient to compensate for the power consumption of the power consumption module in the predetermined charging cycle comprises:
comparing a ratio of the remaining power of the energy storage module to the power consumption of the power consumption module in the predetermined charging cycle; and
in response to the ratio being smaller than the power consumption in the predetermined charging cycle, determining that the remaining power of the energy storage module is not sufficient to compensate for the power consumption of the power consumption module in the predetermined charging cycle.

18. An electronic device comprising: a processor; and a memory storing executable instructions that, when executed by the processor, cause the electronic device to implement the method according to claim 13.

19. A non-transitory computer-readable storage medium on which executable instructions are stored, the executable instruction when executed by a processor of an elevator power supply system to implement the method according to claim 13.

20. A computer program product comprising a program including executable instructions stored on a non-transitory computer-readable medium, the executable instructions when executed by a processor implement the method according to claim 13.

21. A management module of an elevator power supply system of an elevator, the elevator power supply system being connected to a power supply system and including a charging module and an energy storage module, the charging module being electrically connected with the energy storage module by a switchable connection, and the energy storage module being electrically connected with a power consumption module of the elevator by a switchable connection, the management module comprising:
a first control unit adapted to switch the charging module into an on state with the energy storage module such that the charging module charges the energy storage module when the power supply system and/or the elevator power supply system and/or the power consumption module is in an off-peak period and a remaining electrical power of the energy storage module is not sufficient to compensate for a power consumption of the power consumption module in a predetermined charging cycle; and
a second control unit adapted to switch the charging module into an off state with the energy storage module when an amount of the charging by the charging module to the energy storage module reaches a predetermined power threshold.

22. An elevator power supply system of an elevator adapted to connect to a power supply system, the elevator power supply system comprising:
the management module according to claim 21;
a charging module in communication with the management module;
an energy storage module in communication with the management module and electrically connected with the charging module by a switchable connection; and
wherein the management module controls an on-off state connection between the energy storage module and the charging module and controls an on-off state connection between a power consumption module of the elevator and the energy storage module.

23. The elevator power supply system according to claim 22 wherein the energy storage module and the power consumption module are electrically connected through a DC-AC power supply.

24. An elevator comprising:
the elevator power supply system according to claim 22;
a power consumption module; and
wherein the management module of the elevator power supply system controls an on-off state connection between the power consumption module and the energy storage module.
